(19) United States
(12) Patent Application Publication
(10) Pub. No.: US 2026/0095509 A1
(43) Pub. Date: Apr. 2, 2026

(54) METHOD AND APPARATUS FOR SUPPORTING XR SERVICES IN A WIRELESS NETWORK

(71) Applicant: Samsung Electronics Co., Ltd., Suwon-si (KR)

(72) Inventors: Vinay Kumar SHRIVASTAVA, Bangalore (IN); Jajohn Mathew MATTAM, Bangalore (IN)

(21) Appl. No.: 19/343,472

(22) Filed: Sep. 29, 2025

Related U.S. Application Data
(63) Continuation of application No. PCT/KR2025/015144, filed on Sep. 26, 2025.

(30) Foreign Application Priority Data
Sep. 17, 2025 (IN) 2024 41074370
Oct. 1, 2024 (IN) 202441074370

(51) Int. Cl. H04L 67/131; H04W 8/24; H04W 72/21

(52) U.S. Cl. CPC H04L 67/131; H04W 8/24; H04W 72/21

(57) ABSTRACT

A method for supporting at least one extended reality (XR) service by a user equipment (UE), in a wireless network is provided. The method includes generating a UE capability information message that indicates a capability for supporting codec rate adaptation for the at least one XR service; transmitting the UE capability information message to a network apparatus; and receiving at least one codec rate adaptation configuration parameter for the at least one XR service from the network apparatus in response to the UE capability information message.

### CROSS-REFERENCE TO RELATED APPLICATIONS

This application is a continuation application, claiming priority under 35 U.S.C. § 365(c), of an International application No. PCT/KR2025/015144, filed on September 26, 2025, which is based on and claims the benefit of an Indian Provisional patent application number 202441074370, filed on October 1, 2024, in the Indian Intellectual Property Office, and of an Indian Complete patent application number 202441074370, filed on September 17, 2025, in the Indian Intellectual Property Office, the disclosure of each of which is incorporated by reference herein in its entirety.

### FIELD OF INVENTION

The disclosure relates to the field of wireless networks. More particularly, the disclosure relates to a method and system for controlling application or codec rate adaptation for extended reality (XR) services in a wireless network.

### BACKGROUND

XR encompasses a spectrum of immersive technologies, including Virtual Reality (VR), Augmented Reality (AR), and Mixed Reality (MR). These technologies are pivotal for the development and realization of digital twins and the meta-universe, offering unprecedented levels of interaction and immersion. XR has been identified as a critical component in advancing communication systems and has been incorporated as an agreed work item in the fifth generation (5G) Advanced framework, specifically within the scope of third generation partnership project (3GPP) Release 18 and Release 19. These releases aim to provide a communication system framework capable of meeting the demanding requirements of XR applications, which include high data rates, very low latency, and power-efficient connectivity.

Despite the advancements in 5G technology, XR applications face significant challenges due to the dynamic nature of network conditions. One of the primary issues is the need for the application or codec rate to be constantly adjusted to align with fluctuating network performance. This adjustment is crucial to ensure seamless user experiences and to prevent issues such as lag, buffering, or degraded visual quality, which can severely impact the immersive experience that XR technologies are designed to deliver.

The above information is presented as background information only to assist with an understanding of the disclosure. No determination has been made, and no assertion is made, as to whether any of the above might be applicable as prior art with regard to the disclosure.

### OBJECT OF INVENTION

Aspects of the disclosure are to address at least the above-mentioned problems and/or disadvantages and to provide at least the advantages described below. Accordingly, an aspect of the disclosure is to provide a method and system for controlling application or codec rate adaptation for XR services in a wireless network.

Aspects of the disclosure are to provide methods and systems for configuring User Equipment (UE) for rate control for the extended reality in the wireless networks.

Aspects of the disclosure are to provide methods and systems for signaling rate control information for the extended reality in the wireless networks.

Additional aspects will be set forth in part in the description which follows and, in part, will be apparent from the description, or may be learned by practice of the presented embodiments.

### SUMMARY

In accordance with an aspect of the disclosure, a method for supporting at least one extended reality (XR) service by a user equipment (UE) in a wireless network is provided. The method includes generating a UE capability information message that indicates a capability for supporting codec rate adaptation for the at least one XR service, transmitting the UE capability information message to a network apparatus, and receiving at least one codec rate adaptation configuration parameter for the at least one XR service from the network apparatus in response to the UE capability information message.

In accordance with an aspect of the disclosure, a method for supporting at least one extended reality (XR) service in a wireless network. The method includes receiving a UE capability information message for supporting the codec rate adaptation for at least one XR service from a UE, wherein the UE capability information message includes at least one of UE capability for supporting a codec rate adaptation request or query to the network apparatus or the UE capability for supporting codec rate adaptation or control from the network apparatus, configuring at least one codec rate adaptation configuration parameter for the at least one XR service for the UE, and transmitting the at least one codec rate adaptation configuration parameter to the UE.

In accordance with an aspect of the disclosure, a user equipment (UE) for supporting at least one extended reality (XR) service in a wireless network is provided. The UE includes memory storing instructions; and at least one processor operably coupled to the memory. The instructions, when executed by the at least one processor individually or collectively, may cause the UE to generate a UE capability information message that indicates a capability for supporting codec rate adaptation for the at least one XR service, transmit the UE capability information message to a network apparatus, and. receive at least one codec rate adaptation configuration parameter for the at least one XR service from the network apparatus in response to the UE capability information message..

In accordance with an aspect of the disclosure, a network apparatus for supporting at least one extended reality (XR) service in a wireless network is provided. The network apparatus includes memory storing instructions; and at least one processor operably coupled to the memory. The instructions, when executed by the at least one processor individually or collectively, may cause the network apparatus to receive a user equipment (UE) capability information message for supporting codec rate adaptation for the at least one XR service from a UE, wherein the UE capability information message may comprise at least one of a UE capability for supporting a codec rate adaptation request or query to the network apparatus or the UE capability for supporting codec rate adaptation or control from the network apparatus, configuring at least one codec rate adaptation configuration parameters for the at least one XR service for the UE, and. transmitting the at least one codec rate adaptation configuration parameter to the UE.

In accordance with an aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include generating a UE capability information message that indicates a capability for supporting codec rate adaptation for the at least one XR service, transmitting the UE capability information message to a network apparatus, and receiving at least one codec rate adaptation configuration parameter for the at least one XR service from the network apparatus in response to the UE capability information message.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF FIGURES

The above and other aspects, features, and advantages of certain embodiments of the disclosure will be more apparent from the following description taken in conjunction with the accompanying drawings, in which:

FIG. 1 is a schematic diagram that illustrates a schematic of the UE implemented to carry out the disclosed subject matter according to an embodiment of the disclosure;

FIG. 2 is a schematic diagram that illustrates a schematic of the network apparatus implemented to carry out the disclosed subject matter according to an embodiment of the disclosure;

FIG. 3 is a flow diagram that illustrates a method for determining the need or configuring a congestion status and employing an application or codec rate adaptation or control according to an embodiment of the disclosure;

FIG. 4 is a flow diagram that illustrates a method for controlling application or codec rate adaptation for XR services by the UE according to an embodiment of the disclosure;

FIG. 5 is a flow diagram that illustrates a method for triggering and sending an uplink (UL) rate control medium access control (MAC) control element (CE) message requesting for desired or preferred bitrates according to an embodiment of the disclosure;

FIG. 6 is a flow diagram that illustrates a method for indicating recommended or allowed bitrates to upper layers according to an embodiment of the disclosure;

FIG. 7 is a flow diagram that illustrates a method for triggering a bit rate query according to an embodiment of the disclosure;

FIG. 8 is a flow diagram that illustrates a method for adding desired or preferred bitrates in the UL rate control MAC CE according to an embodiment of the disclosure;

FIG. 9 is a flow diagram that illustrates a method for controlling application or codec rate adaptation for XR services by the network apparatus according to an embodiment of the disclosure; and

FIG. 10 is a flow diagram that illustrates a method for providing recommended or allowed bitrates to the UE according to an embodiment of the disclosure.

The same reference numerals are used to represent the same elements throughout the drawings.

### DETAILED DESCRIPTION OF INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

As is existing in the field, embodiments are described and illustrated in terms of blocks that carry out a described function or functions. These blocks, which referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and optionally be driven by firmware and software. The circuits, for example, be embodied in a plurality of semiconductor chips, or on substrate supports such as printed circuit boards, and the like. The circuits constituting a block be implemented by dedicated hardware, or by a processor (e.g., a plurality of programmed microprocessors and associated circuitry), or by a combination of dedicated hardware to perform some functions of the block and a processor to perform other functions of the block. Each block of the embodiments be physically separated into two or more interacting and discrete blocks without departing from the scope of the proposed method. Likewise, the blocks of the embodiments be physically combined into more complex blocks without departing from the scope of the proposed method.

The accompanying drawings are used to help easily understand various technical features and it is understood that the embodiments presented herein are not limited by the accompanying drawings. As such, the proposed method is construed to extend to any alterations, equivalents, and substitutes in addition to those which are particularly set out in the accompanying drawings. Although the terms first, second, etc. used herein to describe various elements, these elements are not be limited by these terms. These terms are generally used to distinguish one element from another.

Currently, there is no standardized mechanism within the 3GPP framework to systematically and reliably manage rate control for XR applications. This absence of a standardized solution results in inconsistent application performance and can lead to inefficient use of network resources. Consequently, the lack of a reliable rate control mechanism presents a significant barrier to the widespread adoption and effective utilization of XR technologies.

The proposed solution discloses methods and systems for rate control for XR in wireless networks. The method includes configuring the UE for rate control for the extended reality in the wireless networks. The method includes determining, composing, and sending the rate control query or request for the extended reality in the wireless networks. The method includes providing by the network the rate control information for the UE based on the corresponding rate control query or request.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth^{®} chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

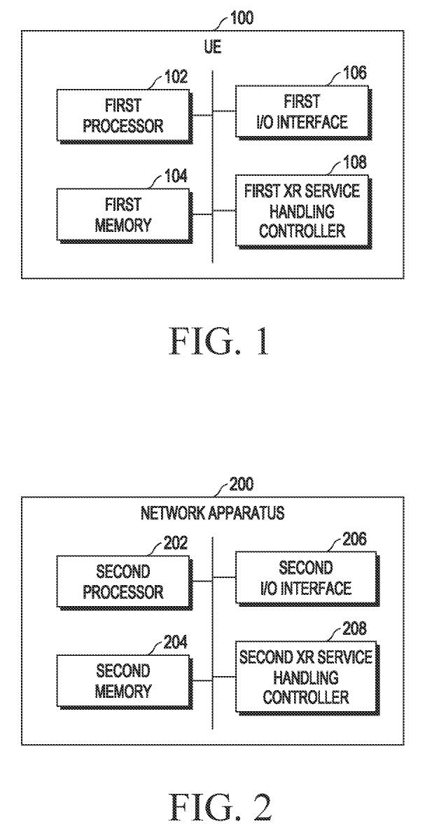

FIG. 1 is a block diagram that illustrates a schematic of a UE (100) implemented to carry out the disclosed subject matter according to an embodiment of the disclosure.

Examples of the UE (100) can include, but are not limited to, Consumer Electronics (such as Mobile Phones and Smartphones), Tablets, Wearable Devices, Computing Devices (such as Laptops, Notebooks, Desktops, Workstations, etc.), internet of things (IoT) Devices, Automotive Systems (such as connected cars, Autonomous Vehicles, Vehicle-to-Everything (V2X) communication devices, etc.), Enterprise Devices such as robotics, Specialized Equipment (such as Medical Devices, Public Safety Devices, etc.), Media Devices (such as Gaming Consoles, Streaming Devices, etc.).

Referring to FIG. 1, the UE (100) includes a first processor (102), first memory (104), a first input/output (I/O) interface (106), and a first XR service handling controller (108) coupled to the first processor (102) and the first memory (104). The components are explained in further detail below.

The first processor (102) communicate with the first memory (104), the first I/O interface (106), and the first XR service handling controller (108). The first processor (102) are configured to execute instructions stored in the first memory (104) and to perform various processes. The first processor (102) includes one or a plurality of processors, is a general-purpose processor such as the CPU, an application processor (AP), or the like, a graphics-only processing unit such as a graphics processing unit (GPU), a visual processing unit (VPU), and/or an Artificial Intelligence (AI) dedicated processor such as a neural processing unit (NPU).

The first memory (104) includes storage locations to be addressable through the first processor (102). The first memory (104) stores UE capability information, codec rate adaptation configuration parameters for the XR services, and the like. The first memory (104) is not limited to a volatile memory and/or a non-volatile memory. Further, the first memory (104) includes a plurality of computer-readable storage media. The first memory (104) includes non-volatile storage elements. For example, non-volatile storage elements include magnetic hard disks, optical disks, floppy disks, flash memories, or forms of electrically programmable read only memories (EPROMs) or electrically erasable and programmable ROM (EEPROM) memories. The instructions, when are executed by the first processor (102) (individually or collectively by the plurality processors of the first processor (102)), may cause the UE (100) to executed operations of the UE (100) described herein.

The first I/O interface (106) transmits the information between the first memory (104) and external peripheral devices. The peripheral devices are the input-output devices associated with the UE (100). Further, the first XR service handling controller (108) communicates with the first I/O interface (106) and the first memory (104). The first XR service handling controller (108) is coupled to the first memory (104) and the first processor (102). This coupling allows for efficient data transfer and communication between the components, ensuring that the first XR service handling controller (108) can enable controlling application or codec rate adaptation for XR services in a wireless network.

The first XR service handling controller (108) is an innovative integrated circuit that is implemented in the UE (100). In an embodiment, the structure of such innovative integrated circuit includes a multi-core architecture that enables controlling application or codec rate adaptation for XR services in a wireless network. Each core is optimized for specific tasks, such as generating a UE capability information message, generating UL rate control MAC CE message requesting for desired or preferred bitrates, triggering a bit rate query, and the like. The innovative integrated circuit for the above-mentioned points is made of a combination of analog and digital components designed to enable controlling application or codec rate adaptation for XR services in a wireless network. The analog components include a low-noise amplifier and a high-precision analog-to-digital converter to ensure accurate signal processing. The digital components consist of a microcontroller unit (MCU) and a digital signal processor (DSP) that work in tandem to enable controlling application or codec rate adaptation for XR services in a wireless network.

FIG. 2 is a schematic diagram that illustrates a schematic of a network apparatus implemented to carry out the disclosed subject matter according to an embodiment of the disclosure.

Referring to FIG. 2, a network apparatus (200) includes various hardware and software components that facilitate communication between user equipment and network infrastructure. Examples of the network apparatus (501) can include, but is not limited to Base Stations (such as macro cells, small cells, femtocells, picocells) for wireless communication, Antennas and radio frequency (RF) Units (e.g., multiple-input and multiple-output (MIMO), beamforming) to enhance signal coverage and data throughput, Core Network Equipment (e.g., mobility management entities (MMEs), serving gateways (S-GWs), packet data network gateways (P-GWs) in fourth generation (4G); access and mobility management functions (AMFs), user plane functions (UPFs) in 5G or equivalent entities in sixth generation (6G)) for data routing, mobility, and session control, Network Function Virtualization (NFV) and Software-Defined Networking (SDN) for dynamic resource allocation and scalability, Edge Computing Nodes (e.g., multi-access edge computing (MEC) servers) for low-latency processing, Backhaul and Transport Equipment (e.g., fiber-optic links, microwave relays, Ethernet switches) to connect base stations to the core network, Network Management Systems (NMS) and Operation Support Systems (OSS) for network configuration, fault management, and optimization, Radio Network Controllers (RNCs) in 3G, Distributed Units (DUs), and Centralized Units (CUs) in 5G, Network Slicing Components for virtualized resource allocation, Security elements (e.g., Firewalls, intrusion detection system (IDS), authentication, authorization, and accounting (AAA) Servers) for secure communication.

Referring to FIG. 2, the network apparatus (200) includes a second processor (202), second memory (204), a second I/O interface (206), and a second XR service handling controller (208) coupled to the second processor (202) and the second memory (204). The components are explained in further detail below.

The second processor (202) communicate with the second memory (204), the second I/O interface (206), and the second XR service handling controller (208). The second processor (202) are configured to execute instructions stored in the second memory (204) and to perform various processes. The second processor (202) includes one or a plurality of processors, is a general-purpose processor such as the CPU, an application processor (AP), or the like, a graphics-only processing unit such as a graphics processing unit (GPU), a visual processing unit (VPU), and/or an Artificial Intelligence (AI) dedicated processor such as a neural processing unit (NPU).

The second memory (204) includes storage locations to be addressable through the second processor (202). The second memory (204) stores codec rate adaptation configuration parameters for the XR services for the UE (100). The second memory (204) is not limited to a volatile memory and/or a non-volatile memory. Further, the second memory (204) includes a plurality of computer-readable storage media. The second memory (204) includes non-volatile storage elements. For example, non-volatile storage elements include magnetic hard disks, optical disks, floppy disks, flash memories, or forms of EPROM or EEPROM memories. The instructions, when are executed by the second processor (202) (individually or collectively by the plurality processors of the second processor (202)), may cause the network apparatus (200) to executed operations of the network apparatus (200) described herein.

The second I/O interface (206) transmits the information between the second memory (204) and external peripheral devices. The peripheral devices are the input-output devices associated with the network apparatus (200). Further, the second XR service handling controller (208) communicates with the second I/O interface (206) and the second memory (204). The second XR service handling controller (208) is coupled to the second memory (204) and the second processor (202). This coupling allows for efficient data transfer and communication between the components, ensuring that the second XR service handling controller (208) can enable controlling application or codec rate adaptation for XR services in a wireless network.

The second XR service handling controller (208) is an innovative integrated circuit that is implemented in the network apparatus (200). In an embodiment, the structure of such innovative integrated circuit includes a multi-core architecture that enables controlling application or codec rate adaptation for XR services in a wireless network. Each core is optimized for specific tasks, such as configuring codec rate adaptation configuration parameters for the XR services for the UE (100). The innovative integrated circuit for the above-mentioned points is made of a combination of analog and digital components designed to enable controlling application or codec rate adaptation for XR services in a wireless network. The analog components include a low-noise amplifier and a high-precision analog-to-digital converter to ensure accurate signal processing. The digital components consist of a microcontroller unit (MCU) and a digital signal processor (DSP) that work in tandem to enable controlling application or codec rate adaptation for XR services in a wireless network.

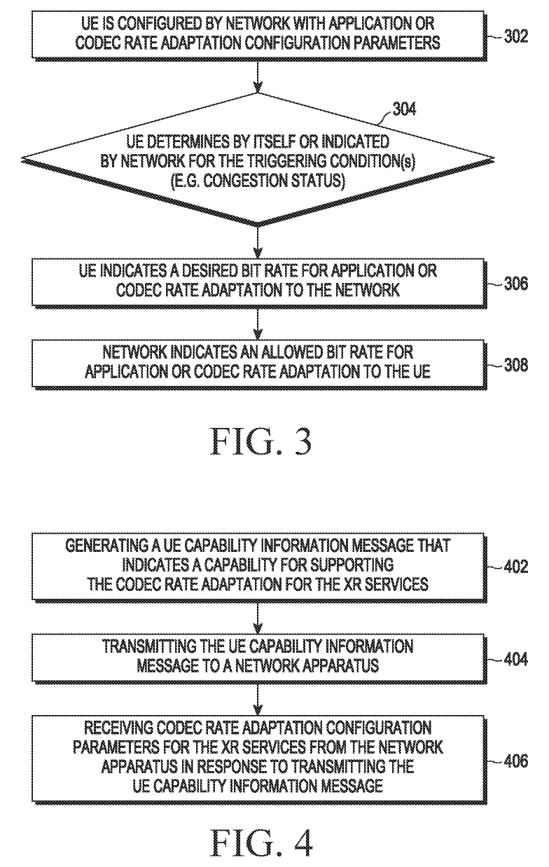

FIG. 3 is a flow diagram that illustrates a method for determining or configuring a congestion status and employing an application or codec rate adaptation or control according to an embodiment of the disclosure.

Referring to FIG. 3, at operation 302, the UE (100) is configured with application or codec rate adaptation configuration parameters by the network apparatus (200). At operation 304, the UE (100) determines triggering condition(s) by itself (for example, due to a congestion status) or indicates the triggering condition(s) by itself. At operation 306, the UE (100) indicates desired or preferred bitrates for the application or codec rate adaptation parameters to the network apparatus (200). At operation 308, the network apparatus indicates allowed or recommended bitrates to the UE (100) for the application or codec rate adaptation parameters.

In an embodiment, the UE (100) indicates the capability for supporting the XR application or codec rate adaptation or control to the network apparatus (200) in a Radio Resource Control (RRC) signaling message, such as a UE capability information message or a UE assistance information message. The UE capability information message may comprise at least one of the UE capability for supporting the codec rate adaptation request or query to the network apparatus (200) and the UE capability for supporting codec rate adaptation or control from the network apparatus (200). This indication allows the network apparatus (200) to understand the capabilities of the UE (100) and requirements for XR applications, thereby enabling the network apparatus (200) to allocate resources more efficiently and ensure a high-quality XR experience for the user. The network apparatus (200) can then configure the UE (100) with the appropriate parameters for rate control, ensuring that the XR application operates smoothly even under varying network conditions.

In an embodiment, the network apparatus (200) configures the UE (100) with the configuration for the application or codec rate adaptation query or request. The configuration may include various parameters for triggering conditions or criteria such as congestion level, battery level, handover, redirection, channel conditions, a threshold change in application or codec rate, identity or identities for applicable logical channel (LC), logical channel group (LCG), radio bearer (RB), Quality of Service (QoS) flow (QF), modality, or a mapping between them, direction (e.g., uplink, downlink, or both), threshold rates, desired rate or range of rates, power mode, Discontinuous Reception (DRX) parameters, a prohibit timer, and a periodic timer. These parameters enable the UE (100) to dynamically adjust its rate control settings based on real-time network conditions and application requirements, thereby optimizing performance and resource utilization.

In an embodiment, the UE (100) informs or indicates the application or codec rate adaptation or control query or request to the network apparatus (200). The signaling utilizes at least one of RRC signaling messages (e.g., a UE assistance information (UAI) message) or a Medium Access Control (MAC) signaling message (e.g., MAC control element (CE)). The query or request may include various parameters for triggering conditions or criteria such as congestion level, battery level, handover, redirection, channel conditions, a threshold change in application or codec rate, identity or identities for applicable logical channel, logical channel group, radio bearer, QoS flow, modality, or a mapping between them, direction (e.g., uplink, downlink, or both), threshold rates, desired rate or range of rates, power mode, DRX parameters. In an embodiment, the MAC entity may be requested by upper layers or applications to query the network apparatus (200) for the application or codec rate adaptation or control. This ensures that rate control queries are initiated based on comprehensive information from various layers and applications, enhancing the overall efficiency and effectiveness of the rate control mechanism.

In an embodiment, the network apparatus (200) provides the MAC entity of the UE (100) with information about the application or codec rate. The rate may be determined based on the network conditions (e.g., congestion) and/or the UE (100) requests or query for the application or codec rate adaptation or control and/or desired rate. The rate may be the bit rate of the physical layer. Further, an averaging window of a specified or a configured duration and/or a default value may be applied. This averaging window helps in smoothing out short-term fluctuations in the rate, providing a more stable and consistent rate control mechanism. By considering both the network conditions and the requirements of the UE (100), the network apparatus (200) can provide a rate that optimally balances performance and resource utilization.

In an embodiment, a rate adaptation query prohibit timer may be configured for a specific logical channel, logical channel group, radio bearer, QoS flow, modality, or a mapping between them and a direction (e.g., uplink, downlink, or both). The rate adaptation query prohibit timer is started when the MAC entity has triggered a rate adaptation query, and the MAC entity has uplink resources allocated for new transmission, and the allocated uplink resources can accommodate a rate adaptation query MAC CE plus its sub-header as a result of logical channel prioritization (LCP). This timer helps in preventing excessive rate adaptation queries, which could otherwise lead to signaling overhead and inefficiencies. The UE (100) starts the rate adaptation query prohibit timer for each QoS flow for which the bit rate query is included in a UL rate control MAC CE message and cancels, the bit rate query. By carefully managing the timing and frequency of rate adaptation queries, the system ensures that resources are used judiciously, maintaining a balance between responsiveness and efficiency.

In an embodiment, the MAC entity cancels the rate adaptation query when it is transmitted. This ensures that redundant or unnecessary queries do not congest the network apparatus (200), thereby optimizing the overall system performance. The cancellation mechanism can be particularly useful in scenarios where the rate adaptation query is no longer relevant due to changes in the network conditions or user requirements. For instance, if the network conditions improve or degrade significantly after the query has been transmitted, the MAC entity can cancel the query to prevent outdated information from affecting the rate adaptation process.

In an embodiment, when the rate adaptation query prohibit timer (e.g., for a specific logical channel, radio bearer, QoS flow, or modality) is running, a new rate adaptation query (e.g., for a specific logical channel, radio bearer, QoS flow, or modality) is not transmitted. This prohibition mechanism helps to avoid the transmission of multiple rate adaptation queries within a short time frame, which can lead to unnecessary signaling overhead and potential conflicts in the rate adaptation process. By enforcing a prohibit timer, the system ensures that rate adaptation queries are spaced out appropriately, allowing the network apparatus (200) to stabilize and adapt to the most recent query before a new one is introduced.

In an embodiment, the rate adaptation query MAC CE is identified by a MAC sub-header with a specific logical channel identity (LCID) or an extended LCID (eLCID). This identification mechanism allows the MAC entity to accurately associate each rate adaptation query with the corresponding logical channel or extended logical channel, ensuring that the rate adaptation process is correctly applied to the intended data flow. The use of LCID or eLCID provides flexibility in addressing different types of logical channels, including those that require extended identification due to their unique characteristics or higher-level requirements. Additionally, the rate adaptation query MAC CE can be of fixed or variable size, depending on the specific implementation and the amount of information that needs to be conveyed. A fixed-size MAC CE simplifies the processing and reduces the overhead, while a variable-size MAC CE allows for more detailed and dynamic rate adaptation queries.

In an embodiment, the rate adaptation information MAC CE is identified by a MAC sub header with a specific LCID or an eLCID. Further the rate adaptation information MAC CE can be of fixed size or of a variable size.

In an embodiment, if the MAC reset of the MAC entity is requested by upper layers or the reset of the MAC entity is triggered due to secondary cell group (SCG) deactivation, the MAC entity may cancel any triggered application or codec rate adaptation or control query or request procedure. This ensures that the rate adaptation process is not disrupted by the reset and that any pending queries or requests are appropriately handled. By canceling these procedures, the MAC entity can prevent inconsistencies and ensure a smooth transition during the reset process. Furthermore, the MAC CE for application or codec rate adaptation or control query or request is prioritized over at least one of the MAC CE for recommended bit rate query, MAC CE for Buffer Status Reporting (BSR) included for padding, and MAC CE for Side-Link Buffer Status Reporting (SL-BSR) included for padding. This prioritization ensures that critical rate adaptation queries are processed promptly, maintaining the quality of service and optimizing the overall network performance.

In an embodiment, the MAC CE for recommended bit rate query is re-utilized for the purpose of the MAC CE for application or codec rate adaptation or control query or request. In an embodiment, a distinguishing identifier or a field may be used to determine the new purpose. In an embodiment, the per QoS flow or per data radio bearer (DRB) based application or codec rate adaptation or control query or request is achieved with the re-utilization of the MAC CE for recommended bit rate query (that is, instead of LCID in the legacy MAC CE for recommended bit rate query).

In an embodiment, the MAC CE for recommended bit rate information is re-utilized for the purpose of the MAC CE for application or codec rate adaptation or control information. In an embodiment, a distinguishing identifier or a field may be used to determine the new purpose. In an embodiment, the per QoS flow or per DRB based application or codec rate adaptation or control information is achieved with the re-utilization of the MAC CE for recommended bit rate information (that is, instead of LCID in the legacy MAC CE for recommended bit rate information).

In an embodiment, the UE (100) detects the congestion on the uplink and accordingly indicates a rate adaptation query or request to the network apparatus (200). The UE (100) autonomously detects congestion and/or determines congestion based on configurations provided by the network apparatus (200), such as buffer status thresholds, delay thresholds, etc. The detection and/or determination of the congestion can be per logical channel/LCG/radio bearer/service/QoS flow/modality or commonly for all logical channels/LCGs/radio bearers/services/QoS flows/modalities. This autonomous detection allows the UE (100) to proactively manage its transmission rates, ensuring efficient use of network resources and maintaining the quality of service for the end-user.

In an embodiment, the UE (100) detects congestion based on a configured threshold for the number of packet data convergence protocol (PDCP) service data units (SDUs)/protocol data units (PDUs) discarded due to the expiry of the legacy discard timer. The threshold can be configured per logical channel/LCG/radio bearer/service/QoS Flow/modality. When the number of discarded PDCP PDUs crosses the configured threshold, the UE (100) triggers procedures associated with congestion-based application or codec rate adaptation or control query or request. This method enables the UE (100) to dynamically adjust its behavior in response to real-time network conditions, thereby optimizing performance and reducing the likelihood of data loss or service degradation.

In an embodiment, the network apparatus (200) (e.g. next generation node B (gNodeB) or Radio Access Network (RAN)) determines the congestion over the uplink. In an embodiment, the network apparatus (200) indicates the congestion activation status and/or congestion deactivation status to the UE (100) for the purpose of application or codec rate adaptation query or request to the network apparatus (200). The congestion activation status and/or congestion deactivation status may be per logical channel or per radio bearer or per logical channel group or per QoS flow or per modality or as per the mapping between them. The congestion activation status and/or congestion deactivation status may be indicated through a MAC signaling message (e.g., MAC CE). By providing this information, the network apparatus (200) can guide the UE (100) in making informed decisions about rate adaptation, ensuring that both the network apparatus (200) and the UE (100) operate efficiently under varying load conditions. In an embodiment, the level or degree of congestion (e.g. low, medium or high) may be indicated explicitly or implicitly in the MAC CE. In an embodiment, the level or degree of congestion may be directly or indirectly indicated by the allowed or recommended bit rate in the MAC CE by the network apparatus (200).

In an embodiment, the MAC CE for PDU Set Importance (PSI) based SDU discard is utilized as the congestion activation status and/or congestion deactivation status for the purpose of rate adaptation query or request to the network apparatus (200). This leverages existing signaling mechanisms to convey critical information about network conditions, simplifying the implementation and reducing the need for additional signaling overhead. By using PSI-based SDU discard, the network apparatus (200) can prioritize more important data packets, thereby maintaining the quality of essential services even under congested conditions.

In an embodiment, upon receiving congestion activation status indication from the network apparatus (200), the UE (100) initiates the application or codec rate adaptation or control query or request procedure and triggers sending of an application or codec rate adaptation or control query or request MAC CE.

In an embodiment, upon receiving congestion deactivation status indication from the network apparatus (200), the UE (100) initiates the application or codec rate adaptation or control query or request procedure and triggers sending of an application or codec rate adaptation or control query or request MAC CE.

In an embodiment, upon receiving congestion deactivation status indication from the network apparatus (200), the UE (100) implicitly reverts the application or codec rate to the same level as before the congestion activation.

In an embodiment, upon receiving congestion deactivation status indication from the network apparatus (200), the UE (100) changes the application or codec rate to the level as explicitly directed, if any, by the network apparatus (200).

In an embodiment, the MAC CE for application or codec rate adaptation or control query or request from the UE (100) to the network apparatus (200) includes at least one parameter for the identity of logical channel/LCG/radio bearer/QoS Flow or modality for which the application or codec rate adaptation or control request is being made, a parameter for direction of uplink or downlink or both, a parameter for desired bit rate, a parameter for bit rate multiplier wherein the actual value of bit rate is the value of the index indicated by the bit rate field multiplied by the parameter for bit rate multiplier, a parameter for bit rate divider wherein the actual value of bit rate is the value of the index indicated by the bit rate field divided by the parameter for bit rate divider, a parameter for triggering cause (e.g., congestion, battery status), and one or more reserved bits. This comprehensive set of parameters allows the UE (100) to precisely communicate its rate adaptation needs to the network apparatus (200), facilitating efficient and effective management of network resources. In an embodiment, a new set of values are defined or specified or configured for bit rate multiplier parameter. In an embodiment, a new set of values are defined or specified or configured for bit rate divider parameter.

In an embodiment, the MAC CE for application or codec rate adaptation or control information from the network apparatus (200) to the UE (100) includes at least one parameter for the identity of logical channel/LCG/radio bearer/QoS Flow or modality for which the application or codec rate adaptation or control request is being made, a parameter for direction of uplink or downlink or both, a parameter for allowed or applied bit rate, a parameter for bit rate multiplier wherein the actual value of bit rate is the value of the index indicated by the bit rate field multiplied by the parameter for bit rate multiplier, a parameter for bit rate divider wherein the actual value of bit rate is the value of the index indicated by the bit rate field divided by the parameter for bit rate divider, a parameter for triggering cause (e.g., congestion, battery status), and one or more reserved bits. This detailed feedback from the network apparatus (200) ensures that the UE (100) can adjust its transmission rates in accordance with current network conditions, thereby optimizing overall network performance. In an embodiment, a new set of values are defined or specified or configured for bit rate multiplier parameter. In an embodiment, a new set of values are defined or specified or configured for bit rate divider parameter.

In an embodiment, the desired bit rate in the MAC CE for application or codec rate adaptation or control query or request from the UE (100) to the network apparatus (200) includes an index to a pre-specified or a pre-configured table of bit rates. This indexing mechanism simplifies the communication of desired bit rates, reducing the complexity and size of signaling messages. By referencing a pre-configured table, the UE (100) can quickly and efficiently indicate its preferred transmission rates, facilitating rapid adaptation to changing network conditions.

In an embodiment, the allowed bit rate in the MAC CE for application or codec rate adaptation or control information from the network apparatus (200) to the UE (100) includes an index to a pre-specified or a pre-configured table of bit rates. This approach ensures consistency and compatibility between the UE (100) and the network apparatus (200), as both entities reference the same table of bit rates. By using indexed bit rates, the network apparatus (200) can efficiently communicate allowed transmission rates to the UE (100), enabling precise control over data flows and optimizing network utilization.

In an embodiment, the allowed bit rate in the MAC CE for application or codec rate adaptation or control information from the network apparatus (200) to the UE (100) may indicate a specific index or a reserved index that is interpreted as no new allowed bit rate being provided by the network apparatus (200). This flexibility allows the network apparatus (200) to either specify a new allowed bit rate or maintain the current rate, depending on the prevailing network conditions. By using a reserved index to indicate no change, the network apparatus (200) can minimize unnecessary signaling and maintain efficient operation.

In an embodiment, the UE (100) is configured by the network apparatus (200) with application or codec adaptation parameters. The UE (100) determines by itself or is indicated by the network apparatus (200) for triggering conditions such as congestion status. For instance, if the network apparatus (200) experiences high traffic, the UE (100) can detect this congestion and adjust its data rate accordingly to prevent packet loss and maintain a stable connection. The UE (100) indicates a desired bit rate for application or codec rate adaptation on the network apparatus (200). The network apparatus (200) then evaluates the network conditions and indicates an allowed bit rate for application or codec rate adaptation for the UE (100). This two-way communication ensures that the data rate is optimized based on both the requirements of the UE (100) and the capacity of the network apparatus (200). This thereby enhancing the overall efficiency and performance of the extended reality application.

Furthermore, the system's ability to adapt to varying network conditions not only improves user experience but also enhances network resource utilization. By dynamically adjusting the bit rate, the system can prevent network congestion and ensure fair distribution of bandwidth among multiple users.

FIG. 4 is a flow diagram that illustrates a method for controlling application or codec rate adaptation for XR services by the UE (100) according to an embodiment of the disclosure. The method includes operations 402-412. Each operation is explained in further detail below.

Referring to FIG. 4, at operation 402, the UE (100) generates a UE capability information message that indicates a capability for supporting the codec rate adaptation for the XR services. For instance, the UE capability information message includes the UE capability for supporting the codec rate adaptation request or query to the network apparatus (200) and the UE capability for supporting codec rate adaptation or control from the network apparatus (200). At operation 404, the UE (100) transmits the UE capability information to the network apparatus (200).

At operation 406, the UE (100) receives codec rate adaptation configuration parameters for the XR services from the network apparatus (200) in response to transmitting the UE capability information message. The codec rate adaptation configuration parameters includes a plurality of triggering conditions and a set of parameters. The trigger conditions include buffer status report (BSR) thresholds associated with the UE (100), a network load associated with the UE (100), a congestion associated with the UE (100), a battery level associated with the UE (100), a temperature associated with the UE (100), delay thresholds associated with the UE (100), and a number of discarded protocol data units (PDUs) exceeding a threshold. The set of parameters include an identity of quality-of-service (QoS) flow for codec rate adaptation and a prohibit timer.

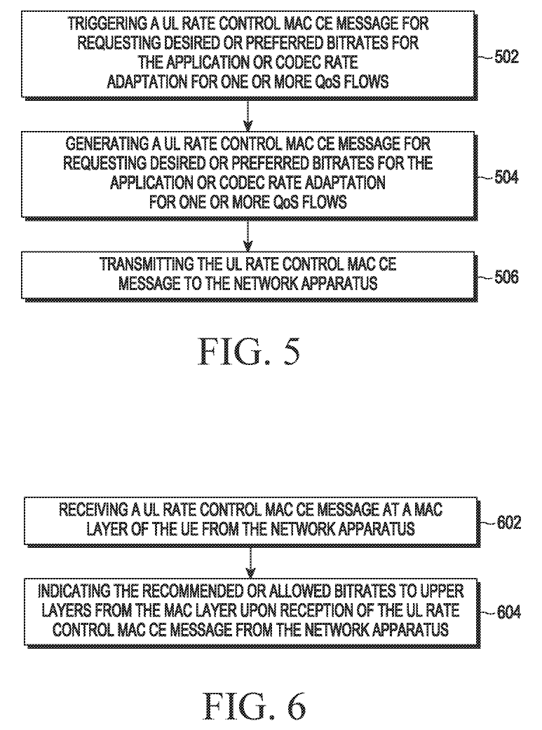

FIG. 5 is a flow diagram that illustrates a method for obtaining a UL rate control MAC CE message upon requesting for desired or preferred bitrates according to an embodiment of the disclosure. The method includes operations 502-506. Each operation is explained in further detail below.

Referring to FIG. 5, at operation 502, the UE (100) triggers a UL rate control MAC CE message for requesting desired or preferred bitrates for the application or codec rate adaptation for one or more QoS flows. The UE (100) triggers the UL rate control MAC CE message based on implementations associated with the UE (100). Once triggered, the UL rate control MAC CE message is transmitted to the network apparatus (200).

At operation 504, the UE (100) generates a UL rate control MAC CE message for requesting desired or preferred bitrates for the application or codec rate adaptation for one or more QoS flows. The UE (100) requests the desired or preferred bitrates based on the plurality of triggering conditions or the codec rate adaptation configuration parameters configured by the network apparatus (200). At operation 506, the UE (100) transmits the UL rate control MAC CE message to the network apparatus (200).

FIG. 6 is a flow diagram that illustrates a method for indicating recommended or allowed bitrates to upper layers according to an embodiment of the disclosure. The method includes operations 602-604. Each operation is explained in further detail below.

Referring to FIG. 6, at operation 602, the UE (100) receives a UL rate control MAC CE message at a MAC layer of the UE (100) from the network apparatus (200). The UL rate control MAC CE message includes recommended or allowed bitrates for one or more QoS flows. The UL rate control MAC CE includes one or more QoS flow identifiers (ID) and bit rate fields. The QoS flow ID identifies the QoS flow for the recommended or allowed bitrates in a bit rate recommendation from the network apparatus (200. The bit rate field indicates indicating the recommended or allowed bitrates in a bit rate recommendation from the network apparatus (200). At operation 604, the UE (100) indicates the recommended or allowed bitrates to upper layers from the MAC layer. This is indicated to upper layers upon reception of the UL Rate Control MAC CE message from the network apparatus (200).

FIG. 7 is a flow diagram that illustrates a method for triggering a bit rate query according to an embodiment of the disclosure. The method includes operations 702-704. Each operation is explained in further detail below.

Referring to FIG. 7, at operation 702, the MAC layer of the UE (100) triggers a bit rate query for the QoS flows upon request by the upper layers for the preferred UL bit rate. This is triggered when no other bit rate query is already pending for the QoS flows. The UE (100) generates a UL rate control MAC CE message upon triggering the bit rate query. The UL rate control MAC CE message includes the desired or preferred bitrates for the application or codec rate adaptation for the QoS flows, and an indication for identities of the QoS flows. The UL rate control MAC CE message is identified by a MAC sub-header with eLCID. The identities of the QoS flows are indicated by a bitmap and the desired and preferred bitrates provided as an index to a pre-specified table of bit rates. At operation 704, the UE (100) transmits the UL rate control MAC CE to the network apparatus (200).

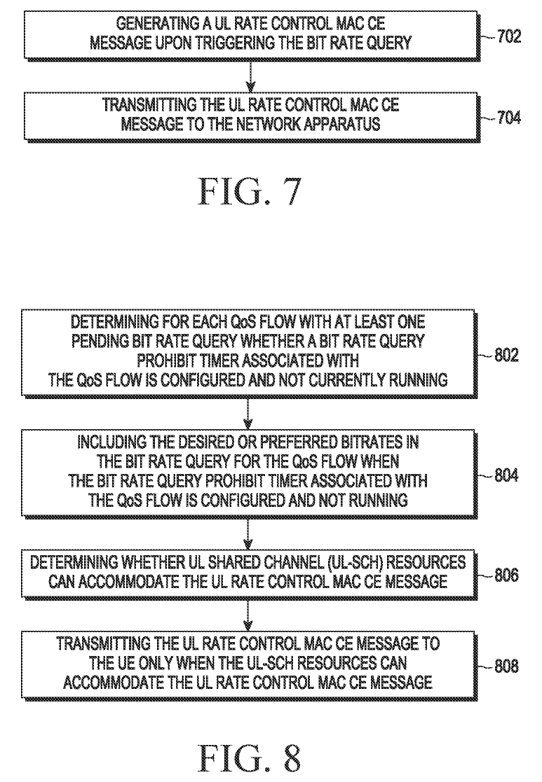

FIG. 8 is a flow diagram that illustrates a method for adding desired or preferred bitrates in the UL rate control MAC CE according to an embodiment of the disclosure. The method includes operations 802-808. Each operation is explained in further detail below.

Referring to FIG. 8, at operation 802, the UE (100) determines, for each QoS flow with a bit rate query pending, whether a bit rate query prohibit timer associated with the QoS flow is configured and not currently running. At operation 804, the UE (100) includes the desired or preferred bitrates in the bit rate query for the QoS flow. This is included when the bit rate query prohibit timer associated with the QoS flow is configured and not running. The bit rate query remains pending after being triggered until it is cancelled.

At operation 806, the UE (100) determines whether uplink shared channel (UL-SCH) resources can accommodate the UL rate control MAC CE message. This includes a sub-header of the UL rate control MAC CE message and preferred bit rate of at least one of the pending bit rate queries, as a result of logic channel prioritization. Further, the logic channel prioritization includes prioritizing of a MAC CE for the bit rate query over the MAC CE for a BSR included for padding, and the MAC CE for a side-link buffer status reporting (SL-BSR) included for padding. At operation 808, the UE (100) transmits the UL rate control MAC CE message to the UE (100) only when the UL-SCH resources can accommodate the UL rate control MAC CE message. The UL rate control MAC CE includes the sub-header of the UL rate control MAC CE message and preferred bit rate of the at least one of the pending bit rate queries.

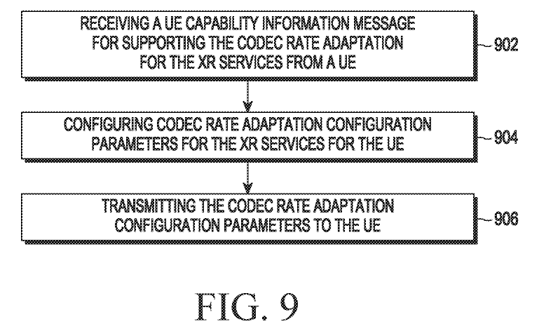

FIG. 9 is a flow diagram that illustrates a method for controlling application or codec rate adaptation for XR services by the network apparatus (200) according to an embodiment of the disclosure. The method includes operations 902-906. Each operation is explained in further detail below.

Referring to FIG. 9, at operation 902, the network apparatus (200) receives a UE capability information message for supporting the codec rate adaptation for the XR services from the UE (100). The UE capability information message includes the UE capability for supporting the codec rate adaptation request or query to the network apparatus (200) and the UE capability for supporting codec rate adaptation or control from the network apparatus (200). At operation 904, the network apparatus (200) sets or configures codec rate adaptation configuration parameters for the XR services for the UE (100). At operation 906, the network apparatus (200) transmits the codec rate adaptation configuration parameters to the UE (100).

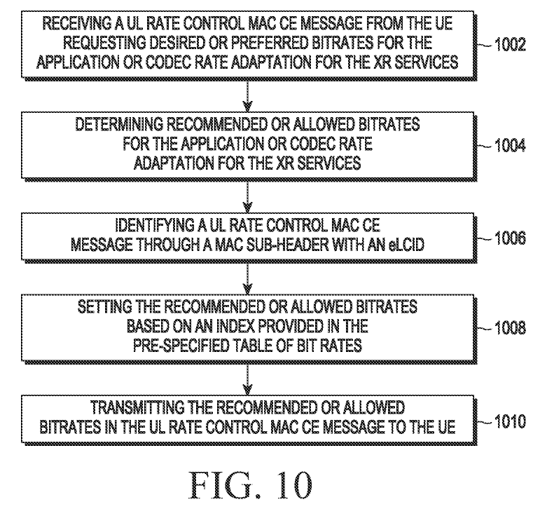

FIG. 10 is a flow diagram that illustrates a method for obtaining recommended or allowed bitrates according to an embodiment of the disclosure. The method includes operations 1002-1010. Each operation is explained in further detail below.

Referring to FIG. 10, at operation 1002, the network apparatus (200) receives a UL rate control MAC CE message from the UE (100) requesting desired or preferred bitrates for the application or codec rate adaptation for one or more QoS flows for the XR services. The UE (100) may request the desired or preferred bitrates based on a plurality of triggering conditions or the codec rate adaptation configuration parameters configured by the network apparatus (200). Further, the UE (100) may trigger the UL rate control MAC CE message based on implementations associated with the UE (100).

At operation 1004, the network apparatus (200) determines recommended or allowed bitrates for the application or codec rate adaptation for one or more QoS flows for the XR services. At operation 1006, the network apparatus (200) identifies the UL rate control MAC CE message through a MAC sub-header with an eLCID. The network apparatus (200) includes the identities of the one or more QoS flows indicated with a bitmap. At operation 1008, the network apparatus (200) sets the recommended or allowed bitrates based on an index provided in the pre-specified table of bit rates. The recommended or allowed bitrates in the UL rate control MAC CE message are then transmitted to the UE (100) at operation 1010.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method for supporting at least one extended reality (XR) service by a user equipment (UE) in a wireless network, the method comprising:
generating a UE capability information message that indicates a capability for supporting codec rate adaptation for the at least one XR service;
transmitting the UE capability information message to a network apparatus; and
receiving at least one codec rate adaptation configuration parameter for the at least one XR service from the network apparatus in response to the UE capability information message.

2. The method of claim 1, wherein the UE capability information message comprises at least one of:
UE capability for supporting a codec rate adaptation request or query to the network apparatus; or
UE capability for supporting codec rate adaptation or control from the network apparatus.

3. The method of claim 1, wherein the at least one codec rate adaptation configuration parameter comprise at least one of:
at least one of a plurality of triggering conditions including at least one of:
buffer status report (BSR) thresholds associated with the UE,
a network load associated with the UE,
a congestion associated with the UE,
a battery level associated with the UE,
a temperature associated with the UE,
delay thresholds associated with the UE, or
a number of discarded protocol data units (PDUs) exceeding a threshold, or
a set of parameters including at least one of:
an identity of quality-of-service (QoS) flow for codec rate adaptation, or
a prohibit timer for uplink rate query.

4. The method of claim 1, further comprising:
generating an uplink (UL) rate control medium access control (MAC) control element (CE) message for requesting desired or preferred bitrates for an application or codec rate adaptation for one or more QoS flows,
wherein the UE requests the desired or preferred bitrates based on the plurality of triggering conditions or the codec rate adaptation configuration parameters configured by the network apparatus; and
transmitting the UL rate control MAC CE message to the network apparatus,
wherein the UL rate control MAC CE message comprises at least one of:
a QoS flow identifier (ID) wherein the QoS flow ID identifies a QoS flow for a desired or preferred bitrate from the UE; or
a bit rate field indicating a desired or preferred bitrates in a bit rate query from the UE.

5. The method of claim 1, further comprising:
triggering a UL rate control MAC CE message for requesting desired or preferred bitrates for an application or codec rate adaptation for one or more QoS flows,
wherein the UE triggers the UL rate control MAC CE message based on implementations associated with the UE; and
transmitting the UL rate control MAC CE message to the network apparatus,
wherein the UL rate control MAC CE message comprises at least one of:
a QoS flow identifier, ID, wherein the QoS flow ID identifies a QoS flow for a desired or preferred bitrate from the UE; or
a bit rate field indicating a desired or preferred bitrates in a bit rate query from the UE.

6. The method of claim 1, comprising:
receiving, by a UE, a UL rate control MAC CE message at a MAC layer of the UE from the network apparatus,
wherein the UL rate control MAC CE message comprises recommended or allowed bitrates for one or more QoS flows; and
indicating, by the UE, the recommended or allowed bitrates to upper layers from the MAC layer upon reception of the UL rate control MAC CE message from the network apparatus,
wherein the UL rate control MAC CE message comprises at least one of:
a QoS flow identifier (ID) wherein the QoS flow ID identifies a QoS flow for the recommended or allowed bitrates; or
a bit rate field indicating the recommended or allowed bitrates.

7. The method of claim 4, wherein the MAC layer triggers a bit rate query for the one or more QoS flows upon request by upper layers for a preferred UL bit rate, when no other bit rate query is already pending for the QoS flows.

8. The method of claim 7, the UL rate control MAC CE message is gnenerated upon triggering the bit rate query,
wherein the UL rate control MAC CE message is identified by a MAC sub-header with an extended logical channel identity (eLCID), and
wherein QoS flow IDs are indicated by a bitmap and the desired or preferred bitrates are provided as an index to a pre-specified table of bit rates.

9. The method of claim 7, further comprising:
determining for each QoS flow with pending bit rate query whether a bit rate query prohibit timer associated with the QoS flow is configured and not currently running; and
including the desired or preferred bitrates in the bit rate query for the QoS flow when the bit rate query prohibit timer associated with the QoS flow is configured and not running,
wherein the bit rate query remains pending after being triggered until it is cancelled.

10. The method of claim 7, further comprising:
starting a bit rate query prohibit timer for each QoS flow for which the bit rate query is included in a UL rate control MAC CE message; and
cancelling the bit rate query.

11. The method of claim 7, further comprising:
determining whether UL shared channel (UL-SCH) resources can accommodate the UL rate control MAC CE message, including a sub-header of the UL rate control MAC CE message and a preferred bit rate of at least one of the pending bit rate queries, as a result of logic channel prioritization; and
transmitting the UL rate control MAC CE message to the UE only when the UL-SCH resources can accommodate the UL rate control MAC CE message, including the sub-header of the UL rate control MAC CE message and preferred bit rate of at least one of the pending bit rate queries.

12. The method of claim 11, wherein the logic channel prioritization comprises prioritizing of a MAC CE for the bit rate query over the MAC CE for a BSR included for padding, and the MAC CE for a side-link buffer status reporting (SL-BSR) included for padding.

13. The method of claim 1, further comprising:
determining whether a reset of a MAC entity of the UE is requested by upper layers or a reset of MAC entity of the UE is triggered due to a secondary cell group (SCG) deactivation; and
cancelling a triggered UL rate control procedure when the reset of the MAC entity of the UE is requested by upper layers or the reset of the MAC entity of the UE is triggered due to the SCG deactivation.

14. A method for supporting at least one extended reality (XR) service in a wireless network, the method comprising:
receiving a user equipment (UE) capability information message for supporting the codec rate adaptation for the at least one XR service from a UE, wherein the UE capability information message comprises at least one of UE capability for supporting a codec rate adaptation request or query to a network apparatus or UE capability for supporting codec rate adaptation or control from the network apparatus;
configuring at least one codec rate adaptation configuration parameter for the at least one XR service for the UE; and
transmitting the at least one codec rate adaptation configuration parameter to the UE.

15. The method of claim 14, further comprising:
receiving a first uplink (UL) rate control medium access control (MAC) control element (CE) message from the UE requesting desired or preferred bitrates for an application or codec rate adaptation for one or more quality-of-service (QoS) flows,
wherein the UE requests the desired or preferred bitrates based on a plurality of triggering conditions or the at least one codec rate adaptation configuration parameter configured by the network apparatus, or
wherein the UE triggers the UL rate control MAC CE message based on implementations associated with the UE.

16. The method of claim 15, comprising:
determining recommended or allowed bitrates for the application or codec rate adaptation for the one or more QoS flows; and
transmitting the recommended or allowed bitrates in a second UL rate control MAC CE message to the UE.

17. The method of claim 16, wherein determining recommended or allowed bitrates for the application or codec rate adaptation for the one or more QoS flows is based on at least one of a detection of a network congestion or an overload condition, or an alleviation of the network congestion or the overload condition.

18. The method of claim 16, wherein determining the recommended or allowed bitrates for the application or codec rate adaptation for the one or more QoS flows comprises:
identifying a UL rate control MAC CE message through a MAC sub-header with an extended logical channel identity (eLCID);
including identities of the one or more QoS flows indicated with a bitmap; and
setting the recommended or allowed bitrates based on an index provided in a pre-specified table of bit rates.

19. A user equipment (UE) for supporting at least one extended reality (XR) service in a wireless network, the UE comprising:
memory storing instructions; and
at least one processor operably coupled to the memory, wherein the instructions, when executed by the at least one processor individually or collectively, cause the UE to:
generate a UE capability information message that indicates a capability for supporting codec rate adaptation for the at least one XR service,
transmit the UE capability information message to a network apparatus, and
receive at least one codec rate adaptation configuration parameter for the at least one XR service from the network apparatus in response to the UE capability information message.

20. The UE of claim 19, wherein the UE capability information message comprises at least one of:
UE capability for supporting a codec rate adaptation request or query to the network apparatus; or
UE capability for supporting codec rate adaptation or control from the network apparatus.
